(19) United States
(12) Patent Application Publication
(10) Pub. No.: US 2015/0195875 A1
(43) Pub. Date: Jul. 9, 2015

(54) TECHNOLOGY TO DESENSITIZE LED LAMPS AGAINST POWER RIPPLES

(71) Applicant: LT LIGHTING (TAIWAN) CORP., Hsinchu (TW)

(72) Inventors: Geoffrey Wen-Tai Shuy, Taipei City (TW); Chang-Horang Li, Hsinchu City (TW); Hsin-Chen Lai, Taichung City (TW); Wen Ten Chang, Kaohsiung City (TW)

(21) Appl. No.: 14/665,829

(22) Filed: Mar. 23, 2015

Related U.S. Application Data
(63) Continuation-in-part of application No. 14/068,934, filed on Oct. 31, 2013.

(51) Int. Cl. H05B 33/08

(52) U.S. Cl. CPC H05B 33/0803

(57) ABSTRACT

An LED lamp having an operating voltage range within which if the supply voltage is provided within the operating voltage range, the LED lamp produces light in a designed light range, and which has reduced sensitization to ripples. The LED lamp includes a network of passive elements that are structured such that the I-V characteristic curve has a plateau region within the operating voltage range. For instance, a maximum slope of an I-V characteristic curve of the network is shallower within the operating voltage range than the maximum slope of an I-V characteristic curve of the network below the operating voltage range.

### CROSS-REFERENCE TO RELATED APPLICATIONS

This application is a continuation-in-part application of U.S. patent application Ser. No. 14/068,934, filed Oct. 31, 2013, which patent application is hereby incorporated herein by reference in its entirety.

### BACKGROUND

Conventional LED lamps are very sensitive to power voltage ripples. In operation, LED lamps may be subject to terminal voltage fluctuations due to ripples provided by the power supply; thereby inducing a flickering phenomena in which the LED lamp light emissions flicker. There are two ways to reduce such a flickering phenomenon. First, very strict ripple suppression circuitry or “constant current” circuitry may be incorporated within the power supply. Alternatively, feedback circuitry may be built into the LED lamps to maintain stable lighting.

Conventional approaches of flickering suppression focus on either 1) conditioning the supplied power quality to reduce the terminal voltage ripples, or 2) regulating the supply current through feed-back control circuitry to reduce fluctuation in the current flow through the LED lamps. Thus, these conventional approaches are hereinafter referred to as “supply-side flickering suppression”.

Conventional approaches of flickering suppression focus on either 1) conditioning the supplied power quality to reduce the terminal voltage ripples, or 2) regulating the supply current through feed-back control circuitry to reduce fluctuation in the current flow through the LED lamps. Thus, these conventional approaches are hereinafter referred to as “supply-side flickering suppression”.

### BRIEF SUMMARY

Embodiments described herein aim at developing a technology to cost effectively desensitize LED lamps toward ripples without extra power consumption; and to derive design rules such that the lamps become much less sensitive to the voltage fluctuations due to ripples passing down from the power supplies.

The principles and design rules described herein result in designs for mass-producable ripple-insensitive LED lamps. The embodiments show that LED lamps designed in according with the disclosed principles are insensitive to the power ripples even without extra power consumption. They produce reduced or no flickering phenomena under the ripple conditions that would cause conventional LED lamps to have significant flickering. At least some, and potentially all, of these embodiments do not consume extra power and also can be cost effectively mass produced.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the above-recited and other advantages and features can be obtained, a more particular description of various embodiments will be rendered by reference to the appended drawings. Understanding that these drawings depict only sample embodiments and are not therefore to be considered to be limiting of the scope of the invention, the embodiments will be described and explained with additional specificity and detail through the use of the accompanying drawings in which:

FIG. 1 abstractly illustrates typical I-V characteristics of two types of LED lamp prototypes in Group-A and Group-B respectively, with reference to their typical operating voltage range between Vb and Vb′;

FIG. 2 illustrates I-V characteristics of example LED lamp prototypes modified from group-B, called group-B′ in accordance with the principles described herein, with reference to their operating voltages within a plateau region (between Vb and Vb′) to thereby have high enough current with high ripple tolerance;

FIG. 3 illustrates a circuit diagram of a lighting assembly that produces the I-V characteristics shown in FIG. 2; and

FIG. 4 schematically illustrates I-V characteristics of subgroup 310 without resistor, as curve A; I-V characteristics of the conventional LED network of series connecting 7 units of parallel connecting 4 LEDs, as curve B; and I-V characteristics of subgroup 310 with only resistor R10, as curve C.

### DETAILED DESCRIPTION

This patent disclosure reveals principles and embodiments of novel and inexpensive designs for LED lamps that can increase LED lamp tolerance to terminal voltage fluctuations due to power supply ripples. When powered by the same power supply with ripples (hereinafter “rippled power supply”), conventional LED lamps have severe flickering, while the embodiments described herein have significantly reduced flickering, or even no noticeable flickering.

Conventional LED lamps are very sensitive to power voltage ripples. At their operating point, when the LED lamps are subject to terminal voltage fluctuations induced by power supply ripples, conventional LED lamps produce severe flickering. To suppress the flickering of the conventional LED lamps, the power supply may either be equipped with very strict ripple suppression circuitry or constant current output circuitry. Alternatively, there may be feedback control circuitry built into the LED lamps to stabilize light emissions.

These conventional approaches of flickering suppression focus on either 1) conditioning the supplied power quality to reduce terminal voltage fluctuations or 2) regulating the supply current via feed-back control circuitry for restricting the current fluctuations from passing through the LED lamps. Thus, these conventional approaches are referred to herein as “supply-side flickering suppression”. In contrast, the approach for flicker suppression disclosed herein will be called “demand-side ripple desensitization” or “desensitization against ripples”. The circuits used in the supply-side flickering suppression approaches consume extra power and also induce extra costs, while at least some embodiments of the demand-side approach do not.

Shuy et. al. invented and patented LED lamp powering technologies, published on Aug. 9, 2012 as United States Patent Publication No. 20120200235A1 and issued as U.S. Pat. No. 8,525,441 on Sep. 3, 2013 (submitted herein as a reference). The patented technologies can regulate power consumption of LED lamps. The patented technologies include using networks of LEDs and passive electrical elements to regulate the power consumption of the LED lamps. This demand-side approach can result in designs for the LED lamps to increase efficacy when terminal voltage and/or power consumption are decreased within the designed range.

In one embodiment, steps to come up with an approach to desensitize the LED lamps against powering ripples can be described as follows:

Step (I): Design multiple networks of passive elements, and build a prototype for each design.

Step (II): Measure all the prototypes to and construct a corresponding characteristic file associate with each prototype. Each file includes the I-V characteristics and the L-P characteristics of each corresponding prototype.

Step (III): Design and build a special power supply that can add known voltage-ripples to power these prototypes. Observe the resulting flickering when the special power supply is applied to the prototype. The observed flickering is compared with the degree of flickering from a set of purchased conventional LED lamps that are powered by the same special power supply.

Step (IV): Categorize the prototypes into three groups; group A, group B and group C. The prototypes in group-A are those prototypes that have noticeably higher tolerance against the voltage-ripples as compared to the conventional LED lamps. For instance, some or even perhaps all of the prototypes in group A have no noticeable flickering while the conventional LED lamps have serious flickering. In contrast, group-B is to include those prototypes that have no noticeable difference in flickering tolerance when compared with the conventional LED lamps. Group-C is to include prototypes that have some degree of flickering behavior between the group-A and group-B.

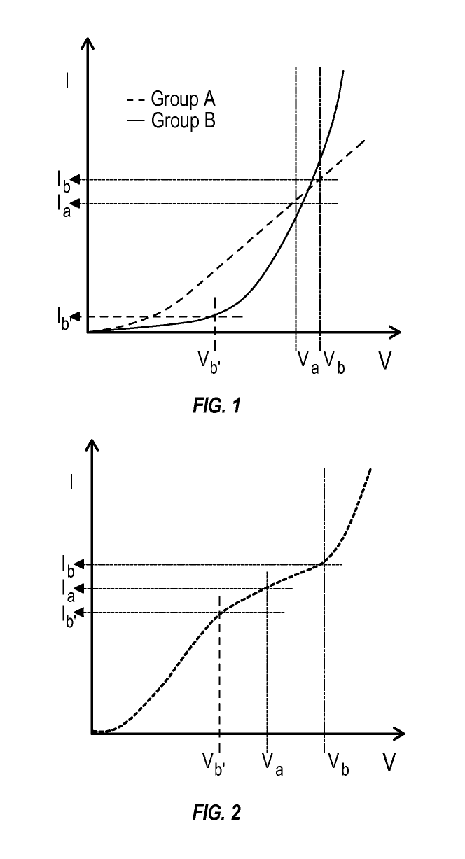

Step (V): Examine the I-V characteristics of the group-A and compare with that of group-B. The inventors found that, within the operating voltages of those prototypes in group-B, the corresponding I-V characteristics showed a steep-sloped within the operating voltage (that is, a given change in voltage resulted in a larger change in current). A typical I-V characteristic of group-B is shown abstractly in FIG. 1. In contrast, the I-V characteristics of the protypes of group A within the operating voltages show a relatively slighter slope (that is, a given change in voltage resulted in a smaller change in current) A typical I-V characteristic of group-A is also shown abstractly in FIG. 1. Furthermore, when measuring and examining the I-V characteristics of the conventional LED lamps, the conventional LED lamps are clearly operating at a very steep slope of the corresponding I-V characteristics. Furthermore, the conventional LED lamps required a strictly supply-side current/voltage control in operation.

Summarized from the study described above, we formulated a design rule that when LED lamps operate at shallower slope of the corresponding I-V characteristics, the LED lamps have higher tolerance against the voltage fluctuations produced from the powering ripples.

We confirmed this conclusion; by temporarily moving the operating points of the prototypes in group-B to the slow slope region of the corresponding I-V characteristics (below the designed operating voltage range; and thus way below the design current). This resulted in the LED lamps gaining tolerance toward the power ripples provided by the special power supply. The same increased ripple tolerance was also observed for conventional LED lamps when they were made to operate in the region of the shallower slope region of their corresponding I-V characteristics (again being below the designed operating voltage range; and thus way below the design current). However, when so reducing the operating voltage below the designed range, the light output of either conventional LED lamps or prototypes in group B are also much reduced when they are operated at the high ripple tolerant region.

However, the design rule derived from the above five invention steps can be further enhanced to come up with practical LED lamps with high tolerance against ripples. Thus, we proceeded further as follows:

Step (VI): Compare the operating currents of those prototypes in group-A and those in group-B. At their designed operating voltages (such as at “Va” shown in FIG. 1), all prototypes of both group-A and group-B are at high enough current and thus enough light output as illustrated abstractly in FIG. 1; but their tolerances against ripples are very different. When the operating voltages of the prototypes of group-B are adjusted downward to the higher ripple tolerance operating voltages, the corresponding operating currents are reduced significantly; as is the light output.

Although they have high tolerance against ripples at the modified operating voltage, the designs in group-B are not suitable for practical LED lamp designs due to inadequate light-output at the new operating voltages. In accordance with embodiments described herein, the design of an LED lamp produces adequate light output while also having high tolerance against ripples.

Step (VII): Abstractly redesign an I-V characteristic for prototypes in group-B; such that the lamps would provide both adequate lighting and also tolerate large ripples. In other words, the LED lamp is designed to have its operating voltage at a region having very shallow slope I-V characteristic, and also having enough current to produce enough light output.

To reiterate, the I-V characteristic of a desirable LED lamp have a “plateau region” having high enough current; and then operate the lamp at the voltage within the plateau region. This I-V characteristic is abstractly illustrated in FIG. 2 shown for the modified design described above.

In this description and in the claims, the I-V characteristic curve has a plateau region if the following two conditions are true: 1) the maximum slope of the I-V characteristic curve is smaller within the operating voltage range than the maximum slope of the I-V characteristic curve below the operating voltage range; and 2) the maximum slope of the I-V characteristic curve increases at a greater slope (than the maximum slope within the operating voltage range) for at least some of the increased voltage before a peak current is reached. As an example, in the case of the first condition, the maximum slope of the I-V characteristic curve within the operating voltage range may be less than 90 percent, 80 percent, 70 percent, 60 percent, 50 percent, 40 percent, or even 30 percent, of the maximum slope of the I-V characteristic curve below the operating voltage range. The smaller the percentage, the less the flickering.

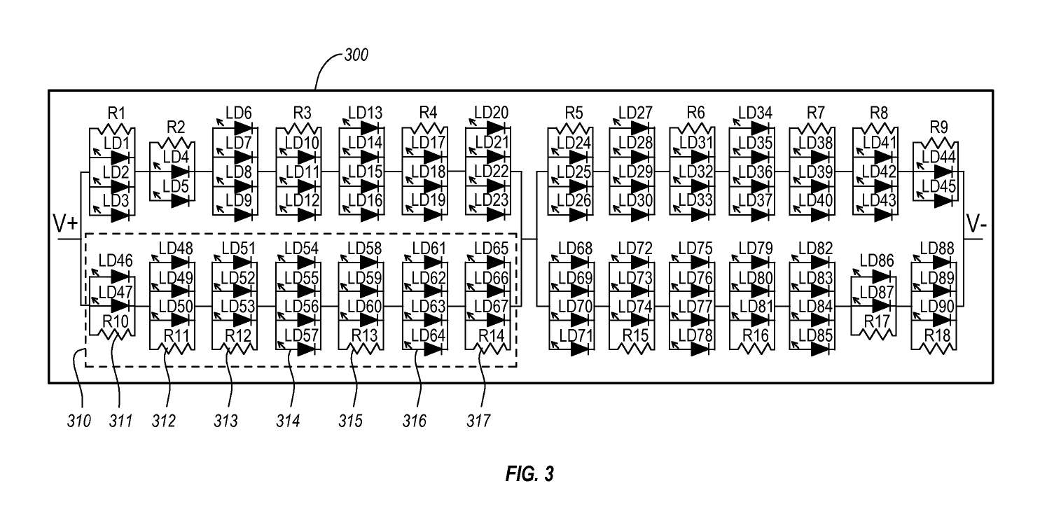

Step (VIII): Follow the principles disclosed in the patented LED powering technologies (Pub. No.: US20120200235A1) to come up a desirable network of LED and passive electrical components. This network exhibits the desired I-V characteristics stated in step (VII). We then build a prototype with the network. As an example, FIG. 3 depicts a circuit of passive network 300 resulted from the exercising this step that may produce a plateau region illustrated in Figure 2. The passive network 300 includes multiple passive components including a combination of LED diodes and resistors. As shown in FIG. (3), a circuit of lighting assembly consists of 90 LED (labeled LD1 through LD90) and 18 resistors (labeled R1 through R18) which are networked into 4 sub-groups, two sub-groups coupled in parallel into 2 groups. The two groups are then coupled in series between two terminals V+ and V− of a power supply; as shown in FIG. (3).

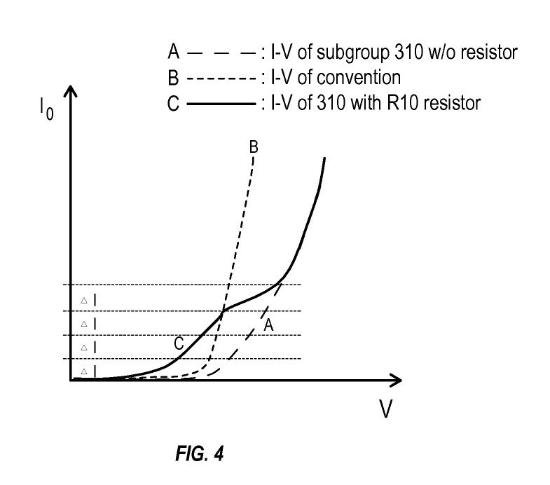

Let us examine the structure in one subgroup 310 in the FIG. (3). The subgroup 310 consists of seven series connecting units 311 through 317. Each unit 311 through 317 comprises parallel connected groups of two to four LEDs with or without resistor. Same current shall flow through each unit 311 through 317 due to series connection. Without losing generality, consider an embodiment in which all the 22 LEDs in subgroup 310 are the same but that the 5 resistors are different. In that embodiment, different numbers of parallel connecting LEDs and resistor can produce different number of parallel connecting current path. In turn, the different parallel connecting current paths give different terminal voltage across each unit 311 through 317. The I-V characteristics of 310 can then be measured with constant increments on current value (ΔI) flow through the subgroup against the summation of the seven terminal voltages, V=V₃₁₁+V₃₁₂+V₃₁₃+V₃₁₄+V₃₁₅+V₃₁₆+V₃₁₇ and plotted as shown schematically in FIG. 4 as curve A.

For instance, the units 314 and 316 consist of 4 LEDs with no resistors; the terminal voltage of the two units shall be at the voltage that can flow ¼ of the current flow through subgroup 310. Let's examine the situation that all the 5 resistor in 310 are chosen to be very large simulating an open circuit. In that case unit 311 is equivalent to having only 2 LEDs and all the units 312, 313, 315, and 317 have only 3 LEDs. In this case each LED in 311 shall carry ½ of the current; each LED in units 312, 313, 315, 317 shall carry ⅓ of the current; while each LED in units 314 and 316 shall carry ¼ of the current flow through 310. The terminal voltage of unit 311 shall be the highest (at the voltage that can flow ½ of the current flow through 310). Furthermore, the units 312, 313, 315 and 317 having 3 LEDs shall be higher than that of the units 314 and 316.

Therefore, the network of seven series connected units consisted of different number of parallel connecting LEDs as schematically shown in FIG. 3 would have shallower Current-Voltage slope than a conventional network consisted of seven series connecting units of parallel connecting 4 LEDs; also shown schematically in FIG. 4 as curve B. Due to LED's diode characteristics, the curve A would approach the similar shape of curve B when current exceed several times of the manufacturer designate operation current of the LED.

Now, let us examine how does the resistors in these units alters the terminal voltage; and thus the I-V characteristics. To see the effect that a resistor can increase the slope of the I-V characteristics in a low voltage region, let us change the assumption slightly from the above. In particular, assume that all the resistor R11, R12, R13 and R14 in subgroup 310 are chosen very large except the resistor R10 in unit 311. Now suppose that the resistance R10 is chosen with a proper finite value of about the value of (3V_{f}/Iₒ) (or less) (the resistance of the resistor being equal to a forward voltage of the number of diodes divided by the current that would flow through a diode in that same unit in the absence of the resistor); where V_{f} is the manufacturer designate forward voltage and Iₒ is the manufacturer designate operation current of the LED. In this situation, when V₃₁₁ is below V_{f}/3, most of the current through unit 311 flows through resistor R10; and not the two parallel connecting LEDs LD46 and LD47. Therefore, when carrying same amount of current the V₃₁₁ is smaller than the previous value (i.e., through two LED without R10). But the current flow through all seven units in 310 shall be the same due to the series connection. This forces the terminal voltage of all other six units 312 through 317 in 310 to reach the same terminal voltages at the same current value; also the same terminal voltages in previous case (without R10). In other words, the summation of V₃₁₁+V₃₁₂+V₃₁₃+V₃₁₄+V₃₁₅+V₃₁₆+V₃₁₇ would be smaller than the value without the resistor R10. Therefore, this effect produces a steeper slope in I-V characteristics in the low voltage region (V₃₁₁<V_{f}/3). However when the V₃₁₁ is at between V_{f}/3 and 0.9V_{f} (the medium voltage region), the LEDs gradually shared more current flow through 311. The larger the value of V₃₁₁, the larger current carrying fraction flow through the LEDs. Therefore the increment of V₃₁₁ is gradually reduced and approaching to the value without resistor R10 at high voltage region (above 1.2V_{f}).

To reiterate, adding resistor R10 to the unit 311 can steepen up the slope in 310 I-V characteristics at low voltage region; then gradually shift into the shallower slope mode in the medium voltage region; and then merges into the I-V curve without resistor in high voltage region. In other words, adding a proper resistor into parallel connected group of LED units, and then series connecting multiple of such units with each other can produce a so call “plateau” region in I-V characteristics of an LED lamp schematically shown in FIG. 4 as curve C. When properly choosing all 18 resistors and 90 LEDs for the LED-resistor passive network shown in FIG. 3, one can fabricate an LED lamp with the I-V characteristics abstractly shown in FIG. 2.

When operating the LED lamp at V_{b}, it has an almost constant current condition at the plateau region (between V_{b}′ and V_{b} shown in FIG. 2) without help from any active component. Thus, this type of LED lamps may be properly considered as being “desensitized” to ripple.

To summarize; the common structure of the desensitized LED lamps as depicted in FIG. 3 can be described as: An LED lamp consists of at least one passive network of series connecting units, wherein each unit has a properly chosen number of parallel connected LEDs and properly chosen values of resistor. By so doing, an almost constant current carrying region can be achieved thereby allowing the LED lamp to be insensitive to the powering voltage ripples without help from any active component.

Step (IX): Measure the relevant characteristics including the I-V, the L-P, and the flickering characteristics. We found that when the prototype operates at its designed operating voltage in the plateau region; it produces adequate lighting and also having very high tolerance against ripples. This step proves the principles derived above are fundamentally correct.

Step (X): To verify the ubiquity of the principles derived from Steps (VI), (VII), and (VIII), we design additional 8 desired I-V characteristics in according to step (VII); with 8 different operating voltages ranging from 24 to 380 Vdc. We go through the invention steps (VIII) and (IX) and found that all of these designed prototypes have the desired light-output and also the having very high tolerance against ripples without extra power consumption.

As described above, we finished the invention steps that derived the principles and design rules to come up with networks of LED and passive electrical elements. We also verified that these principles and design rules can produce the desired networks.

Incorporate these networks to fabricate LED lamps, one can produce the LED lamps that having very high tolerance against terminal voltage fluctuations due to powering ripples and with adequate light output, as all embodiments described above.

In other words, the LED lamps can be designed to be insensitive to terminal voltage fluctuations induced by the powering ripples. Thus, one can power these LED lamps with much simpler and cost effective power supplies.

To verify the conclusion above, we produce two power supplies that just convert 110 VAC or 220 VAC into DC power with very large ripples. We then drove two suitable LED prototypes produced in the Step (X). We found that they both have desirable light outputs and do not have observable flickering at all, while the conventional LED lamps having severe flickering when driven by these two simple power supplies. Since a ripple-suppressed power supply or power supply equipped with constant current feedback control may cost up to 35% of some conventional LED lamps; the principles described herein can improve the affordability of the LED lamps drastically.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. An LED lamp having an operating voltage range within which if the supply voltage is provided within the operating voltage range, the LED lamp produces light in a designed light range, the LED lamp comprising:
a network of passive elements that are structured such that an maximum slope of an I-V characteristic curve of the network is shallower within the operating voltage range than the maximum slope of an I-V characteristic curve of the network below the operating voltage range, the network of passive element comprising:
a plurality of units of that are connected in series between terminals of the network of passive elements,
each of the plurality of units comprising a parallel connected number of passive units that includes a number of diodes,
wherein at least one of the plurality of units comprises a resistor whose resistance value is such that the presence increases the average slope of the I-V characteristic curve below the operating voltage range due to channeling of current through the resistor, but results in a more flat average I-V characteristic curve in the operating voltage range due to transition of the flow from the resistor to the number of diodes within the corresponding unit.

2. The LED lamp in accordance with claim 1, the number of diodes within each of the plurality of diodes being not all the same.

3. The LED lamp in accordance with claim 1, the resistance of a resistor of at least one of the plurality of diodes being approximately equal to a forward voltage of the number of diodes divided by the current that would flow through a diode in that same unit in the absence of the resistor.

4. The LED lamp in accordance with claim 1, the resistance of a resistor of at least one of the plurality of diodes being less than a forward voltage of the number of diodes divided by the current that would flow through a diode in that same unit in the absence of the resistor.

5. The LED lamp in accordance with claim 1, wherein the maximum slope of the I-V characteristic curve of the network increases at a greater slope higher than the operating voltage range before the current reaches a maximum.

6. The LED lamp in accordance with claim 1, wherein the I-V characteristic curve has a plateau region within the operating voltage range.

7. The LED lamp in accordance with claim 1, wherein the maximum slope of the I-V characteristic curve within the operating voltage range is less than 90 percent the maximum slope of an I-V characteristic curve of the network below the operating voltage range.

8. The LED lamp in accordance with claim 1, wherein the maximum slope of the I-V characteristic curve within the operating voltage range is less than 80 percent the maximum slope of an I-V characteristic curve of the network below the operating voltage range.

9. The LED lamp in accordance with claim 1, wherein the maximum slope of the I-V characteristic curve within the operating voltage range is less than 70 percent the maximum slope of an I-V characteristic curve of the network below the operating voltage range.

10. The LED lamp in accordance with claim 1, wherein the maximum slope of the I-V characteristic curve within the operating voltage range is less than 60 percent the maximum slope of an I-V characteristic curve of the network below the operating voltage range.

11. The LED lamp in accordance with claim 1, wherein the maximum slope of the I-V characteristic curve within the operating voltage range is less than 50 percent the maximum slope of an I-V characteristic curve of the network below the operating voltage range.

12. The LED lamp in accordance with claim 1, wherein the maximum slope of the I-V characteristic curve within the operating voltage range is less than 40 percent the maximum slope of an I-V characteristic curve of the network below the operating voltage range.
